(19) United States
(12) Patent Application Publication
(10) Pub. No.: US 2026/0265495 A1
(43) Pub. Date: Sep. 10, 2026

(54) DISHWASHER BASKET AND DISHWASHER HAVING THE SAME

(71) Applicant: SAMSUNG ELECTRONICS CO., LTD., Suwon-si (KR)

(72) Inventors: Minsu KANG, Suwon-si (KR); Nohcheol PARK, 16677 (KR); Jooseong SOHN, 16677 (KR); Jongun CHOI, Suwon-si (KR)

(73) Assignee: SAMSUNG ELECTRONICS CO., LTD., Suwon-si (KR)

(21) Appl. No.: 19/659,786

(22) Filed: Apr. 27, 2026

Related U.S. Application Data
(63) Continuation of application No. PCT/KR2024/014002, filed on Sep. 13, 2024.

(30) Foreign Application Priority Data
Oct. 27, 2023 (KR) 10-2023-0145956
Jun. 17, 2024 (KR) 10-2024-0078558

(51) Int. Cl. C08K 7/14; A47L 15/22; A47L 15/50; C08K 5/00; C08L 77/02

(52) U.S. Cl. CPC C08K 7/14; A47L 15/22; A47L 15/502; C08K 5/005; C08L 77/02; C08L 2201/08

(57) ABSTRACT

A basket for a dishwasher includes a hydrophilic material which includes a polyamide resin, and at least one filler selected from the group consisting of glass fiber, carbon fiber, natural fiber, and talc. The hydrophilic material has a flexural modulus of 30,000 kgf/cm² or more and a contact angle of 65° or less.

### CROSS REFERENCE TO THE RELATED APPLICATION

This application is a continuation application, filed under 35 U.S.C. § 111 (a), of International Application PCT/KR2024/014002 filed Sep. 13, 2024, and is based on and claims priority under 35 U.S.C. § 119 to Korean Patent Applications No. 10-2023-0145956, filed on Oct. 27, 2023 and Korean Patent Applications No. 10-2024-0078558, filed on Jun. 17, 2024, in the Korean Intellectual Property Office, the disclosures of which are incorporated by reference herein in their entireties.

### TECHNICAL FIELD

The present disclosure relates to a basket for a dishwasher and a dishwasher including the same.

### BACKGROUND ART

A dishwasher is a home appliance that automatically washes and dries contaminated cutlery and tableware. Dishwashing includes a washing process of spraying water containing detergent onto dishes placed inside the dishwasher to remove any contaminants, a rinsing process of rinsing the dishes, and a drying process of removing any remaining moisture.

When water droplets on dishes, cutlery, etc. are not rapidly dried, the water droplets may leave water droplet marks, and therefore, the drying process is very important as well as the washing and rinsing processes. Also, the surface energy of the basket on which dishes are placed and which facilitates washing and drying is also very important. Water droplets remaining on the basket after the dishwasher has finished drying are not only unsightly but also may cause discomfort to consumers who use the dishwasher.

The inside of the dishwasher is under a severe environment with high temperature, high humidity, and detergents. Accordingly, materials constituting the interior of the dishwasher also require high heat resistance, durability, and chemical resistance. Conventionally, polypropylene (PP) materials have been appreciated as polymer resins satisfying the conditions and widely used to manufacture the baskets of dishwashers. However, when PP is used alone, there is a problem in that due to the low surface energy of the PP material, water droplets with large contact angles are formed during washing and these water droplets are not sufficiently dried during the drying process, resulting in residual water on the surface of the material.

For this reason, methods such as coating a hydrophilic polymer on the surface of the PP material have been proposed, but these methods have not solved the fundamental problems of the PP material.

### DISCLOSURE

### Technical Problem

An aspect of the present disclosure provides a basket for a dishwasher and a dishwasher including the same, capable of minimizing residual water remaining on a surface of the basket after drying in the dishwasher and having durability even under high-temperature and high-humidity conditions and excellent heat resistance, chemical resistance, and structural stability.

The technical object intended to be achieved by the present disclosure is not limited to the above-mentioned technical objects, and other technical objects not mentioned will be clearly understood by one of ordinary skill in the technical art to which the present disclosure belongs from the following description.

### Technical Solution

A basket for a dishwasher according to an embodiment of the present disclosure may include a hydrophilic material including a polyamide resin; and at least one filler selected from the group consisting of glass fiber, carbon fiber, natural fiber, and talc, the hydrophilic material having a flexural modulus of 30,000 kgf/cm² or more and a contact angle of 65° or less.

Also, the polyamide resin may include at least one selected from the group consisting of polyamide 6 (polycaproamide), polyamide 66 (polyhexamethylene adipamide), and a mixture thereof.

Also, the hydrophilic material may include 54 to 82 parts by weight of the polyamide resin and 20 to 40 parts by weight of the filler, with respect to 100 parts by weight of the hydrophilic material.

Also, the hydrophilic material may further include 3 to 6 parts by weight of at least one hydrophilic additive selected from the group consisting of aliphatic amines, aromatic amines, diamines, polyvinyl alcohol, polyethylene oxide, polyacrylonitrile, silica (SiO₂), and aluminum oxide (Al₂O₃), with respect to 100 parts by weight of the hydrophilic material.

Also, the hydrophilic material may further include at least one antioxidant selected from the group consisting of phenolic, amine-based, phosphite-based, and thioether-based antioxidants.

Also, the hydrophilic material may have a flexural modulus of 40,000 kgf/cm² to 82,000 kgf/cm².

A dishwasher according to an embodiment of the present disclosure may include: a cabinet; a washing tank inside the cabinet; and a basket inside the washing tank, wherein the basket may include a hydrophilic material including a polyamide resin; and at least one filler selected from the group consisting of glass fiber, carbon fiber, natural fiber, and talc, the hydrophilic material having a flexural modulus of 30,000 kgf/cm² or more and a contact angle of 65° or less.

Also, the polyamide resin may include at least one selected from the group consisting of polyamide 6 (polycaproamide), polyamide 66 (polyhexamethylene adipamide), and a mixture thereof.

Also, the hydrophilic material may include 54 to 82 parts by weight of the polyamide resin and 20 to 40 parts by weight of the filler, with respect to 100 parts by weight of the hydrophilic material.

The hydrophilic material may further include 3 to 6 parts by weight of at least one hydrophilic additive selected from the group consisting of aliphatic amines, aromatic amines, diamines, polyvinyl alcohol, polyethylene oxide, polyacrylonitrile, silica (SiO₂), and aluminum oxide (Al₂O₃), with respect to 100 parts by weight of the hydrophilic material.

Also, the hydrophilic material may have a flexural modulus of 40,000 kgf/cm² to 82,000 kgf/cm².

Also, an amount of residual water remaining in the basket after performing a washing operation and a drying operation in a standard course of the dishwasher may be 25 g or less.

### Advantageous Effects

According to a concept of the disclosure, there are provided a basket for a dishwasher and a dishwasher including the same, capable of minimizing residual water remaining on a surface of the basket after drying in the dishwasher and having durability even under high-temperature and high-humidity conditions and excellent heat resistance, chemical resistance, and structural stability.

Effects that may be achieved by the present disclosure are not limited to the above-mentioned effects, and other effects not mentioned will be clearly understood by one of ordinary skill in the technical field to which the present disclosure belongs from the following descriptions.

### DESCRIPTION OF DRAWINGS

FIG. 1 is a perspective view of a dishwasher according to an embodiment of the present disclosure.

FIG. 2 is a cross-sectional view schematically showing a configuration of a dishwasher according to an embodiment of the present disclosure.

FIG. 3 shows a basket according to an embodiment of the present disclosure.

### MODES OF THE INVENTION

Hereinafter, preferred embodiments of the present disclosure will be described. However, the embodiments of the present disclosure may be modified in various different forms, and the technical concept of the present disclosure is not limited to the embodiments which will be described below. Also, the embodiments of the present disclosure are provided to more completely describe the present disclosure for persons having ordinary skill in the related technical field.

Terms used in the present specification are used to describe only specific examples. Hence, an expression used in the singular encompasses the expression of the plural, unless it has a clearly different meaning in the context. In addition, in the present specification, it is to be understood that the terms such as “comprising” or “including” etc., are intended to indicate the existence of the features, operations, components, or combinations thereof disclosed in the specification, and are not intended to preclude the possibility that other features, operations, components, or combinations thereof may exist.

Meanwhile, unless otherwise defined, all terms used in this specification have the same meaning as those generally understood by those of ordinary skill in the technical field to which the present disclosure belongs. Accordingly, unless clearly defined in this application, they will not be understood as ideological or overly formal meanings. It is to be understood that the singular forms “a,” “an,” and “the” in this specification include plural referents unless the context clearly dictates otherwise.

As used in the specification, the terms “about”, “substantially”, or the like, which represents a degree, are used as meanings at numerical values or approaching the numerical values when inherent tolerances of preparation and material are presented to the abovementioned meanings, and they are used to prevent unconscientious invaders from unfairly using the contents in which accurate or absolute numerical values are disclosed in order to help the understandings of the present disclosure.

Generally, a dishwasher is a home appliance used to remove contamination from contaminated dishes. The dishwasher performs a washing process of spraying hot water containing a detergent at a temperature of 40° C. to 75° C. onto contaminated dishes to wash the dishes, a rinsing process of spraying hot clean water onto the washed dishes to rinse the dishes, and a drying process of removing water remaining on the rinsed dishes.

However, any residual water remaining on surfaces of the dishes or an inner surface of the dishwasher after the drying process is not only unsightly but also may cause discomfort to consumers. Furthermore, completely dried dishes may be re-contaminated by the residual water on the inner surface of the dishwasher.

Therefore, the present disclosure may provide a basket for a dishwasher that prevents re-contamination of dishes by minimizing residual water on an inner surface of the dishwasher after drying in the dishwasher by including a hydrophilic material, and has excellent durability, heat resistance, and chemical resistance even under high-temperature and high-humidity conditions using hot water and a detergent.

The basket for the dishwasher according to an embodiment of the present disclosure may include a hydrophilic material including a polyamide (PA) resin; and at least one filler selected from the group consisting of glass fiber, carbon fiber, natural fiber, and talc, the hydrophilic material having a flexural modulus of 30,000 kgf/cm² or more and a contact angle of 65° or less.

Hereinafter, the hydrophilic material included in the basket for the dishwasher according to an embodiment of the present disclosure will be described in detail.

The hydrophilic material included in the basket for the dishwasher according to the present disclosure may include a polyamide resin and a filler.

The polyamide resin may have amide bonds to be polar and may form hydrogen bonds by combining with water, thus having hydrophilic properties.

The polyamide resin may include at least one selected from the group consisting of polyamide 6, polyamide 12, polyamide 66, polyamide 6/66, polyamide 6/12, polyamide 6/6T, polyamide 6/6I, and copolymers thereof.

Preferably, the polyamide resin may include at least one selected from the group consisting of polyamide 6 (polycaproamide), polyamide 66 (polyhexamethylene adipamide), and a mixture thereof.

The polyamide resin may be included preferably in an amount of 54 to 82 parts by weight with respect to 100 parts by weight of the hydrophilic material, more preferably in an amount of 55 to 80 parts by weight, and most preferably in an amount of 58 to 78 parts by weight. In a case where the content of the polyamide resin is less than 54 parts by weight, it may be difficult to obtain a sufficient hydrophilic effect, and furthermore, mechanical properties of the basket for the dishwasher including the hydrophilic material, such as durability, heat resistance, chemical resistance, and structural stability, may be reduced. Also, in a case where the content of the polyamide resin exceeds 82 parts by weight, heat resistance and chemical resistance of the basket for the dishwasher including the hydrophilic material may be reduced, which may increase a molding shrinkage rate, resulting in surface defects during molding of the hydrophilic material.

The polyamide resin may be made in a form of a chip to manufacture a basket for a dishwasher.

The filler may be used together with the polyamide resin to provide mechanical strength to the hydrophilic material.

A kind of the filler may be appropriately selected in consideration of reactivity and compatibility with an amine group of the polyamide resin, and preferably, the filler may include at least one selected from the group consisting of glass fiber, carbon fiber, natural fiber, and talc.

The filler may have a shape, such as fiber, powder, particle, plate, needle, cross, or mat.

The filler may be included preferably in an amount of 20 to 40 parts by weight with respect to 100 parts by weight of the hydrophilic material, more preferably in an amount of 20 to 35 parts by weight, and most preferably in an amount of 20 to 30 parts by weight. In a case where the content of the filler is less than 20 parts by weight, the mechanical properties of the basket for the dishwasher including the hydrophilic material, such as tensile strength, flexural strength, and flexural modulus, may deteriorate, and in a case where the content of the filler exceeds 40 parts by weight, surface defects may occur during molding of the hydrophilic material according to the present disclosure.

In addition, the hydrophilic material included in the basket for the dishwasher according to the present disclosure may include a hydrophilic additive to provide additional hydrophilicity.

The hydrophilic additive may be included in the hydrophilic material together with the polyamide resin to maximize hydrophilicity, thereby reducing a contact angle on a surface of the basket for the dishwasher.

The hydrophilic additive may include at least one selected from the group consisting of aliphatic amines, aromatic amines, diamines, polyvinyl alcohol, polyethylene oxide, polyacrylonitrile, silica (SiO₂), and aluminum oxide (Al₂O₃).

The hydrophilic additive may be included in an amount of 3 to 6 parts by weight with respect to 100 parts by weight of the hydrophilic material. In a case where the content of the hydrophilic additive is less than 3 parts by weight, an effect of providing hydrophilicity to the hydrophilic material through interaction with the polyamide resin may be minimal, and in a case where the content of the hydrophilic additive exceeds 6 parts by weight, durability of the basket for the dishwasher including the hydrophilic material may be reduced.

In addition, the hydrophilic material included in the basket for the dishwasher according to the present disclosure may further include an antioxidant.

The antioxidant may include at least one selected from the group consisting of phenol, amine, phosphite, and thioether groups.

The antioxidant may be included in an amount of 0.01 to 10 parts by weight with respect to 100 parts by weight of the hydrophilic material, and in a case where the content is within the above-mentioned range, a sufficient antioxidative effect may be obtained, thereby improving product stability and durability of the hydrophilic material.

In addition, the hydrophilic material included in the basket for the dishwasher according to the present disclosure may further include an additive, such as a heat-resistant stabilizer, an impact-resistant agent, a plasticizer, a flame retardant, a weather-resistant stabilizer, an antistatic agent, a pigment, a dye, etc., as needed.

The hydrophilic material including the above-mentioned ingredients may have a flexural modulus of 30,000 kgf/cm² or more, preferably, 40,000 kgf/cm² to 82,000 kgf/cm².

In addition, the hydrophilic material may have a contact angle of 65° or less.

That is, the hydrophilic material included in the basket for the dishwasher according to the present disclosure may satisfy the flexural modulus and contact angle within the above-mentioned ranges, thereby exhibiting excellent hydrophilicity, high surface energy, and excellent mechanical properties such as durability, heat resistance, and chemical resistance, which makes it suitable for use in baskets for dishwashers operating under severe environmental conditions of high temperature and high humidity.

Hereinafter, a dishwasher according to an embodiment of the present disclosure will be described.

The dishwasher according to an embodiment of the present disclosure may include: a cabinet; a washing tank provided inside the cabinet; and a basket rested inside the washing tank, wherein the basket may include a hydrophilic material including a polyamide resin; and at least one filler selected from the group consisting of glass fiber, carbon fiber, natural fiber, and talc, the hydrophilic material having a flexural modulus of 30,000 kgf/cm² or more and a contact angle of 65° or less.

Preferably, the hydrophilic material may have a flexural modulus of 40,000 kgf/cm² to 82,000 kgf/cm².

Also, after the dishwasher performs washing and drying in a standard course, an amount of residual water remaining on the basket may be 25 g or less. In this case, the standard course may mean an operation of spraying washing water at a temperature of 50° C. to 60° C. to perform washing and rinsing for 40 minutes to 50 minutes and then performing drying for 10 minutes to 20 minutes in a condition of 50° C. to 60° C. which is an internal temperature.

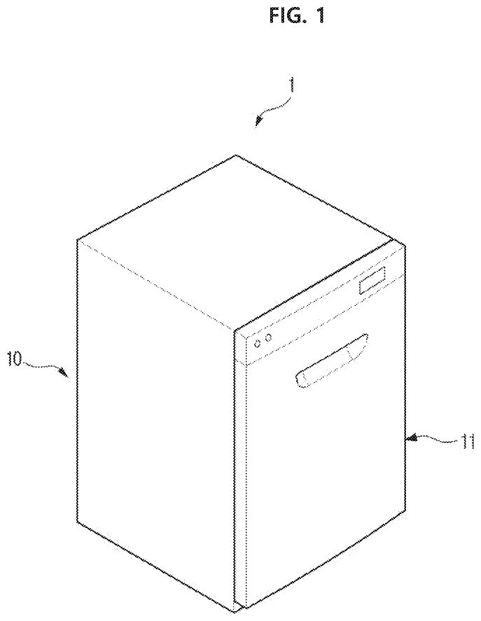

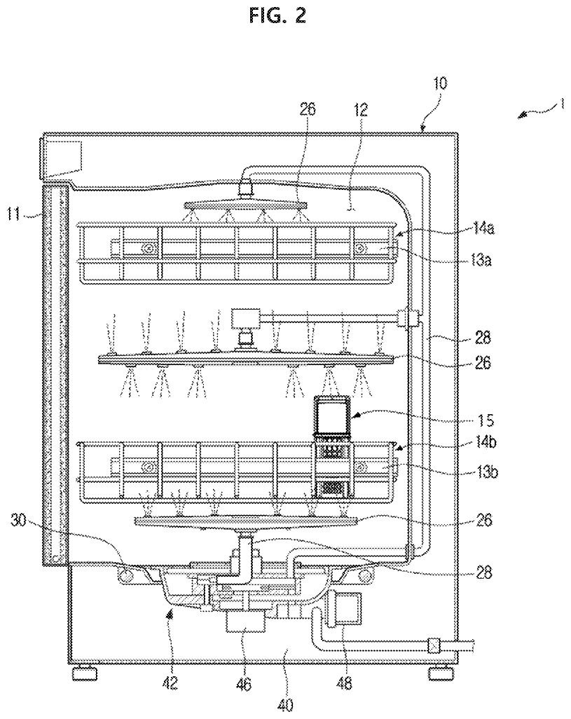

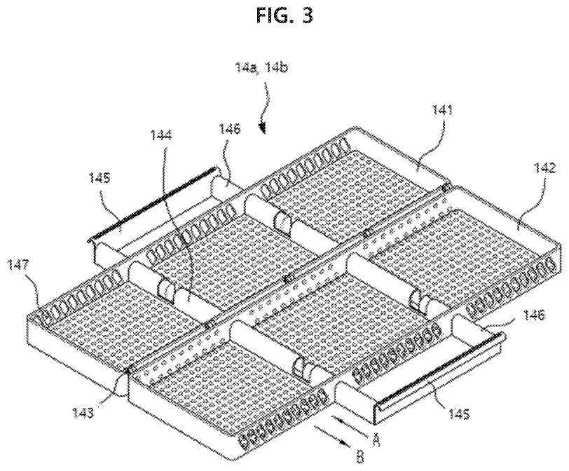

FIG. 1 is a perspective view of a dishwasher according to an embodiment of the present disclosure, FIG. 2 is a cross-sectional view schematically showing a configuration of a dishwasher according to an embodiment of the present disclosure, and FIG. 3 shows a basket according to an embodiment of the present disclosure.

Referring to FIG. 1, the dishwasher 1 may include a cabinet 10 forming an appearance and a door 11 that opens or closes inside of the cabinet 10.

The dishwasher 1 may be an apparatus that sprays washing water onto a washing object such as dishes to wash the washing object, and may be categorized into various types according to a structure and arrangement of the cabinet 10.

The dishwasher 1 may be implemented as a built-in type that is installed in an empty space formed by removing a part of furniture, which is an external support, a free-standing type capable of being installed independently, a counter top type that is placed on an upper counter of furniture, etc., and an in-sink type that is manufactured and installed integrally with a sink. FIG. 1 shows a case in which the dishwasher 1 is implemented as a built-in type generally used for household use, but the dishwasher 1 is not limited thereto.

The door 11 may be rotatably mounted on a front side of the cabinet 10 and at an upper portion of the door 11, a controller may be provided to enable a user to control the dishwasher 1, and the user may easily open or close the door 11 and control the dishwasher 1.

Referring to FIG. 2, the dishwasher 1 according to an embodiment of the present disclosure may include the cabinet 10, a washing tank 12, and a machine room 40.

The washing tank 12 may be a space formed inside the cabinet 10, and baskets 14a and 14b on which dishes being washing objects are placed may be arranged inside the washing tank 12.

The baskets 14a and 14b may include an upper basket 14a and a lower basket 14b. The upper basket 14a may be supported on an upper rack 13a, and the lower basket 14b may be supported on a lower rack 13b. The upper rack 13a and the lower rack 13b may be slidable back and forth inside the washing tank 12.

A spray nozzle 26 for spraying washing water toward the baskets 14a and 14b may be arranged inside the washing tank 12.

The spray nozzle 26 may include an upper spray nozzle 26a, a middle, spray nozzle 26b and a lower spray nozzles 26c. The upper spray nozzle 26a may be installed above the upper basket 14a and spray washing water downward. The middle spray nozzle 26b may be installed between the upper and lower baskets 14a and 14b and spray washing water upward and downward. The lower spray nozzle 26c may be installed below the lower basket 14b and spray washing water upward.

The spray nozzle 26 may be connected to a sump 42 by a supply pipe 28 and receive washing water. The spray nozzle 26 may rotate when washing water is sprayed, thereby evenly spraying the washing water onto a washing object stored in the baskets 14a and 14b.

A heater 30 for heating washing water may be provided on a bottom of the washing tank 12 and a machine room 40 may be provided below the washing tank 12.

Inside the machine room 40, the sump 42 may be provided to collect and pump washing water that is supplied into the washing tank 12 and move the washing water to the spray nozzle 26.

Also, the sump 42 may be provided with various flow paths and a circulation pump 46 for pumping water to the flow paths, and at one side of the sump 42, a drain pump 48 for discharging contaminated washing water to outside via a drain pipe may be provided.

Referring to FIG. 3, the baskets 14a and 14b may include a first basket 141 and a second basket 142. In the first basket 141 or the second basket 142, a space for storing cutlery 15 or dishes may be formed. Meanwhile, the first basket 141 or the second basket 142 may be an injection-molded product having a plurality of holes through which washing water passes.

The baskets 14a and 14b and the cutlery 15 may be made of the hydrophilic material according to the present disclosure described above. Details about the hydrophilic material has been described above, and therefore, redundant descriptions thereof will be omitted.

The first basket 141 and the second basket 142 may be connected to each other by a hinge 143. The first basket 141 or the second basket 142 may match with each other by rotating 180° around the hinge 143. That is, the baskets 14a and 14b may be folded around the hinge 143. The first basket 141 and the second basket 142 may form a space by matching with each other.

The baskets 14a and 14b may include a receiving portion 144, a grip portion 145, and an extension portion 146. The extension portion 146 may be accommodated in the receiving portion 144. The receiving portion 144, the grip portion 145, and the extension portion 146 may be included in each of the first basket 141 and the second basket 142. The grip portion 145 and the extension portion 146 may be installed on a side that is opposite to another side on which the hinge 143 is installed.

The receiving portion 144 may be provided in a form of a hole or groove on one side of the basket 14a or 14b. The extension portion 146 may be accommodated in the receiving portion 144 and slide. A movement limiting portion (not shown) for limiting a movement range of the extension portion 146 may be provided on an inner surface of the receiving portion 144. The extension portion 146 may be limited from being completely separated from the receiving portion 144 by the movement limiting portion (not shown). The movement limiting portion may have a hook structure. A structure that prevents the extension portion 146 from being separated from the receiving portion 144 is not limited thereto.

The grip portion 145 may be connected to the extension portion 146. The grip portion 145 may be formed with a preset curvature, and thus, according to the baskets 14a and 14b being accommodated in a frame (not shown), the grip portion 145 may be hung on the frame. The grip portion 145 may be integrated into the extension portion 146, or may be manufactured separately and then combined with the extension portion 146.

The extension portion 146 may extend from the grip portion 145 and be accommodated in the receiving portion 144. The extension portion 146 may move along the receiving portion 144. As a result, the extension portion 146 may be installed in such a way as to be extendable from the one side of the basket 14a or 14b on which the receiving portion 144 is formed.

That is, a user may slide the extension portion 146 in a direction A to withdraw the extension portion 146 from the receiving portion 144 or may slide the extension portion 146 in a direction B to insert the extension portion 146 into the receiving portion 144, as necessary. The extension portion 146 may be provided with a movement limiting member (not shown) to prevent the extension portion 146 from being completely separated from the receiving portion 144. For example, the movement limiting member (not shown) may have a hook structure, and a hook structure corresponding to the hook structure provided in the receiving portion 144 may be provided in the extension portion 146.

A plurality of inserting holes 147 may be formed in at least one side of the basket 14a or 14b. The inserting holes 147 may be formed only in one side in which the extension portion 146 is installed or may be formed in all sides except for another side that is opposite to the side in which the extension portion 146 is installed. Cutlery may be inserted through the inserting holes 147. A user may insert cutlery into the inserting holes 147 in a state in which the baskets 14a and 14b are folded and then accommodate the baskets 14a and 14b in another rack assembly.

Also, the inserting holes 147 may be formed only in any one of both opposite sides. According to the inserting holes 147 being formed in one side, no inserting holes 147 may be formed in another side that is opposite to the one side. For example, in a case where the plurality of inserting holes 147 are formed in an upper side of the basket 14a or 14b in which the extension portion 146 is installed, no inserting holes 147 may be formed in a lower side of the basket 14a or 14b. As a result, cutlery inserted into the inserting holes 147 formed in the upper side of the basket 14a or 14b may be prevented from escaping downward from the basket 14a or 14b.

Hereinafter, an operation process of the dishwasher 1 configured as described above will be described.

First, when a washing object to be washed is placed in the baskets 14a and 14b inside the washing tank 12 and power is turned on, washing water required for washing may begin to be supplied into the washing tank 12 through a washing water supply hole.

The washing water supplied into the washing tank 12 may be collected into the sump 42 provided on the bottom of the washing tank 12, and then the collected washing water may be supplied to the spray nozzle 26 through the supply pipe 28 by a pumping action of the circulation pump 46 inside the sump 42 and sprayed at high pressure onto the washing object stored in the baskets 14a and 14b, thereby performing a washing operation.

When the washing operation is completed, not only the washing water but also contaminants on the washing object, washed away by the washing water, may be collected in the sump 42, and accordingly, the washing water containing the contaminants may be discharged to the outside via the drain pipe according to an operation of the drain pump 48.

After the washing water containing the contaminants is discharged to the outside, clean washing water may be collected again in the sump 42 through the washing water supply hole, and a rinsing operation may be performed by spraying the washing water at high pressure onto the washing object through each spray nozzle 26 in the same manner as the washing operation described above.

After the rinsing operation is completed, a drying operation may be performed. The drying operation may be performed by operating the heater 30 to spray high-temperature washing water onto the washing object and vaporizing remaining washing water while the high-temperature washing water is vaporized. Alternatively, the drying operation may be performed by spraying high-pressure hot air. When drying is completed, the washing process may terminate.

The cutlery 15 for storing spoons, chopsticks, knives, forks, etc. may be detachably placed on the baskets 14a and 14b. The cutlery 15 is shown as being placed on the lower basket 14b, but is not limited thereto, and may also be placed on the upper basket 14a. The cutlery 15 may be placed in the washing tank 12 to wash spoons or chopsticks.

Hereinafter, the present disclosure will be described in more detail with reference to the following embodiments. However, the following embodiments may be only examples of the present disclosure, and a range of the present disclosure is not limited to these.

### EMBODIMENT

Materials for the basket for the dishwasher were manufactured with compositions shown in Table 1 below.

In Table 1 below, polypropylene (PP), polyamide 6 (PA6, polycaproamide), or polyamide 66 (PA66, polyhexamethylene adipamide) was used as a resin, glass fiber was used as a filler, and polyvinyl alcohol was used as a hydrophilic additive. A unit in Table 1 below is parts by weight with respect to 100 parts by weight of a hydrophilic material.

TABLE 1

| | | | | | Comparative | Comparative | Comparative |
|---|---|---|---|---|---|---|---|
| Classification | Embodiment 1 | Embodiment 2 | Embodiment 3 | Embodiment 4 | Example 1 | Example 2 | Example 3 |
| Resin | PA6 | PA6 | PA6 | PA6 | PP | PP | PP |
| | 80 | 70 | 77 | 80 | 85 | 82 | 79 |
| Filler | 20 | 30 | 20 | 20 | 15 | 15 | 15 |
| Hydrophilic | — | — | 3 | — | — | 3 | 6 |
| Additive | | | | | | | |

With regard to the basket materials manufactured according to Embodiments 1 to 4 and Comparative Examples 1 to 3 of Table 1 above, flexural moduli at a room temperature and at a high-temperature and high-humidity, contact angles, and drying performance were measured, and the results are shown in Table 2 below. The flexural moduli were measured by deforming 6.4T specimens by 30 mm per minute based on ASTM D790 conditions at the room temperature and at the high-temperature and high-humidity (70° C., 60RH %).

The contact angles were obtained by dropping water droplets on surfaces of the respective specimens and measuring the water droplets by using a contact angle measuring device.

The drying performance was obtained by measuring mass (g) of residual water remaining on the baskets after a standard course involved spraying washing water at a temperature of 50° C. to 60° C., washing and rinsing for 40 minutes to 50 minutes, and drying for 10 minutes to 20 minutes at a temperature of 50° C. to 60° C.

TABLE 2

| | | | | | Comparative | Comparative | Comparative |
|---|---|---|---|---|---|---|---|
| Classification | Embodiment 1 | Embodiment 2 | Embodiment 3 | Embodiment 4 | Example 1 | Example 2 | Example 3 |
| Flexural | 62,000 | 82,000 | 62,000 | 64,000 | 33,000 | 33,000 | 33,000 |
| Modulus | | | | | | | |
| (kgf/cm²) at | | | | | | | |
| Room | | | | | | | |
| Temperature | | | | | | | |
| Flexural | 40,000 | 53,000 | 40,000 | 50,000 | 31,000 | 31,000 | 31,000 |
| Modulus | | | | | | | |
| (kgf/cm²) at | | | | | | | |
| High- | | | | | | | |
| Temperature | | | | | | | |
| and High- | | | | | | | |
| Humidity | | | | | | | |
| Contact | 63.6 | 62.0 | 58.5 | 64.0 | 105.0 | 96.0 | 86.0 |
| Angle (°) | | | | | | | |
| Drying | 18.2 | 19.0 | 17.5 | 20.0 | 76.4 | 76.2 | 75.6 |
| Performance (g) | | | | | | | |

A material to be used for a basket for a dishwasher needs to have mechanical properties that are higher than or equivalent to those of PP which is a material used for existing baskets for dishwashers. Therefore, in the present embodiments, flexural moduli were measured as representative test values, and as shown in Table 2 above, the test results confirm that Embodiments 1 to 4 containing 20 parts by weight or more of the filler exhibit significantly improved flexural moduli compared to Comparative Examples 1 to 3 containing 15 parts by weight of the PP and filler used in the existing baskets for dishwashers. In addition, as shown in Table 2, it was confirmed that Embodiments 1 to 4 including the polyamide resin having amide bonds according to the present disclosure exhibit high wettability (hydrophilicity) and high surface energy with a contact angle of about 60°. In contrast, in the cases of Comparative Examples 1 to 3, it was confirmed that even when the content of hydrophilic additive increases, the contact angles were 86° or greater, which indicates low wettability (hydrophobicity) and low surface energy.

In addition, in the cases of Embodiments 1 to 4 including the polyamide resin according to the present disclosure, the masses of residual water remaining on the baskets after drying were 25 g or less, which exhibits drying performance suitable for application to dishwashers, but in the cases of Comparative Examples 1 to 3 using the PP resin, it was confirmed that the masses of residual water were 70 g or more, which exhibit inferior drying performance.

Based on these results, it was found that the hydrophilic material including the polyimide resin and filler according to the present disclosure is suitable for application to dishwashers due to the flexural moduli being 30,000 kgf/cm² or more, the contact angles being 65° or less, and the amounts of residual water remaining on the baskets after washing and drying in the standard course being 25 g or less.

What is claimed is:

1. A basket for a dishwasher, comprising
a hydrophilic material,
wherein the hydrophilic material comprises:
a polyamide resin; and
at least one filler selected from the group consisting of glass fiber, carbon fiber, natural fiber, and talc, and
wherein the hydrophilic material has:
a flexural modulus of 30,000 kgf/cm² or more; and
a contact angle of 65° or less.

2. The basket for the dishwasher of claim 1, wherein
the polyamide resin includes at least one selected from the group consisting of polyamide 6 (polycaproamide), polyamide 66 (polyhexamethylene adipamide), and a mixture thereof.

3. The basket for the dishwasher of claim 1, wherein
the hydrophilic material includes 54 to 82 parts by weight of the polyamide resin and 20 to 40 parts by weight of the filler, with respect to 100 parts by weight of the hydrophilic material.

4. The basket for the dishwasher of claim 3, wherein
the hydrophilic material further includes 3 to 6 parts by weight of at least one hydrophilic additive selected from the group consisting of aliphatic amines, aromatic amines, diamines, polyvinyl alcohol, polyethylene oxide, polyacrylonitrile, silica (SiO₂), and aluminum oxide (Al₂O₃), with respect to 100 parts by weight of the hydrophilic material.

5. The basket for the dishwasher of claim 1, wherein
the hydrophilic material further includes at least one antioxidant selected from the group consisting of phenolic, amine-based, phosphite-based, and thioether-based antioxidants.

6. The basket for the dishwasher of claim 1, wherein
the hydrophilic material has a flexural modulus of 40,000 kgf/cm² to 82,000 kgf/cm².

7. A dishwasher comprising:
a cabinet;
a washing tank inside the cabinet; and
a basket disposed in the washing tank, the basket including a hydrophilic material,
wherein the hydrophilic material comprises:
a polyamide resin; and
at least one filler selected from the group consisting of glass fiber, carbon fiber, natural fiber, and talc, and
wherein the hydrophilic material has a flexural modulus of 30,000 kgf/cm² or more and a contact angle of 65° or less.

8. The dishwasher of claim 7, wherein
the polyamide resin includes at least one selected from the group consisting of polyamide 6 (polycaproamide), polyamide 66 (polyhexamethylene adipamide), and a mixture thereof.

9. The dishwasher of claim 7, wherein
the hydrophilic material includes 54 to 82 parts by weight of the polyamide resin and 20 to 40 parts by weight of the filler, with respect to 100 parts by weight of the hydrophilic material.

10. The dishwasher of claim 7, wherein
the hydrophilic material further includes 3 to 6 parts by weight of at least one hydrophilic additive selected from the group consisting of aliphatic amines, aromatic amines, diamines, polyvinyl alcohol, polyethylene oxide, polyacrylonitrile, silica (SiO₂), and aluminum oxide (Al₂O₃), with respect to 100 parts by weight of the hydrophilic material.

11. The dishwasher of claim 7, wherein
the hydrophilic material has a flexural modulus of 40,000 kgf/cm² to 82,000 kgf/cm².

12. The dishwasher of claim 7, wherein
an amount of residual water remaining on the basket after performing a washing operation and a drying operation in a standard course of the dishwasher is 25 g or less.
